(19) United States
(12) Patent Application Publication
(10) Pub. No.: US 2008/0068403 A1
(43) Pub. Date: Mar. 20, 2008

(54) Scroll control apparatus, scroll control method, and computer product

(75) Inventor: Hiromichi Kobashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/706,206

(22) Filed: Feb. 15, 2007

(30) Foreign Application Priority Data
Sep. 19, 2006 (JP) 2006-252864

(51) Int. Cl. G09G 5/34

(52) U.S. Cl. 345/684

(57) ABSTRACT

Specific information is detected from a portion of image information displayed on a display screen during scrolling the image information. When the detected specific information is displayed at a predetermined position on the display screen as a result of scrolling, the scrolling is stopped. When a predetermined time has elapsed since the scrolling is stopped, the stopping of the scrolling is canceled, to resume the scrolling the image information.

### CROSS-REFERENCE TO RELATED APPLICATIONS

This application is based upon and claims the benefit of priority from the prior Japanese Patent Application No. 2006-252864, filed on Sep. 19, 2006, the entire contents of which are incorporated herein by reference.

### BACKGROUND OF THE INVENTION

1. Field of the Invention

The present invention relates to a scroll control technology for automatically controlling a scroll function in display.

2. Description of the Related Art

In displaying image information on a display device such as a personal computer, a personal digital assistant (PDA), and a cellular phone, all of the image information cannot often be displayed on a display screen at once.

In such a case, a part of the image information displayed on the display screen is scrolled vertically or horizontally to display a part of the image information that has not appeared on the screen. To scroll the image information displayed, a scroll operation is required to be performed by a user, for example, by pressing a scroll button. A large volume of image information requires a user to repeat such operation several times, and this has been an extremely troublesome work for users.

A conventional scroll control apparatus has been provided to solve such a problem. This conventional scroll control apparatus automatically adjusts a scroll speed to an appropriate speed for a user to view the image information, based on the image information to be displayed on the display screen when the image information is being scrolled consecutively (for example, Japanese Patent Application Laid-Open Publication No. 2002-82664). Specifically, if a specific key word is displayed on the display screen, the scroll control apparatus scrolls the image information at a speed corresponding to the key word.

According to the above conventional technique, however, even though the scroll speed is adjusted to an appropriate speed, the image information is still scrolled and a blur image is generated due to a residual image on a liquid crystal monitor of a display device. This often makes it difficult for a user to read the image information properly.

This problem is significant in a portable display device, such as a PDA and a cellular phone, because, in many cases, users of such a portable display device view image information while walking.

Furthermore, to re-read image information failed to be properly read, the user needs to scroll back the image information scrolled away from the view to put the image information back into view on the display screen. As a result, the scroll operation is required to be performed several times, causing troublesome work for the user.

### SUMMARY OF THE INVENTION

It is an object of the present invention to at least solve the above problems in the conventional technologies.

A computer-readable recording medium according to one aspect of the present invention stores therein a scroll control program causing a computer to execute detecting, during a scroll operation of image information, specific information from a displayed portion of the image information, the displayed portion being a portion displayed on a display screen; determining whether the detected specific information is displayed at a predetermined position on the display screen; and stopping the scroll operation when it is determined that the specific information is displayed at the predetermined position at the determining.

A scroll control apparatus according to another aspect of the present invention includes a detecting unit that detects, during a scroll operation of image information, a specific information from a displayed portion of the image information, the displayed portion being a portion displayed on a display screen; a determining unit that determines whether the detected specific information is displayed at a predetermined position on the display screen; and a stopping unit that stops the scroll operation when it is determined that the specific information is displayed at the predetermined position by the determining unit.

A scroll control method according to still another aspect of the present invention includes detecting, during a scroll operation of image information, specific information from a displayed portion of the image information, the displayed portion being a portion displayed on a display screen; determining whether the detected specific information is displayed at a predetermined position on the display screen; and stopping the scroll operation when it is determined that the specific information is displayed at the predetermined position at the determination.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram of a scroll control apparatus according to an embodiment of the present invention;

FIG. 2 is a block diagram of the scroll control apparatus;

FIG. 3 is an explanatory view (1) of an example of a scroll control;

FIG. 4 is an explanatory view (1) of an example of a table;

FIG. 5 is an explanatory view (2) of an example of the scroll control;

FIG. 6 is an explanatory view (3) of an example of the scroll control;

FIG. 7 is an explanatory view (2) of an example of the table;

FIG. 8 is an explanatory view of an example of image information displayed in a window; and

FIG. 9 is a flowchart of a scroll control process executed by the scroll control apparatus.

### DETAILED DESCRIPTION OF THE PREFERRED EMBODIMENTS

Exemplary embodiments of the present invention will now be described in detail with reference to the accompanying drawings.

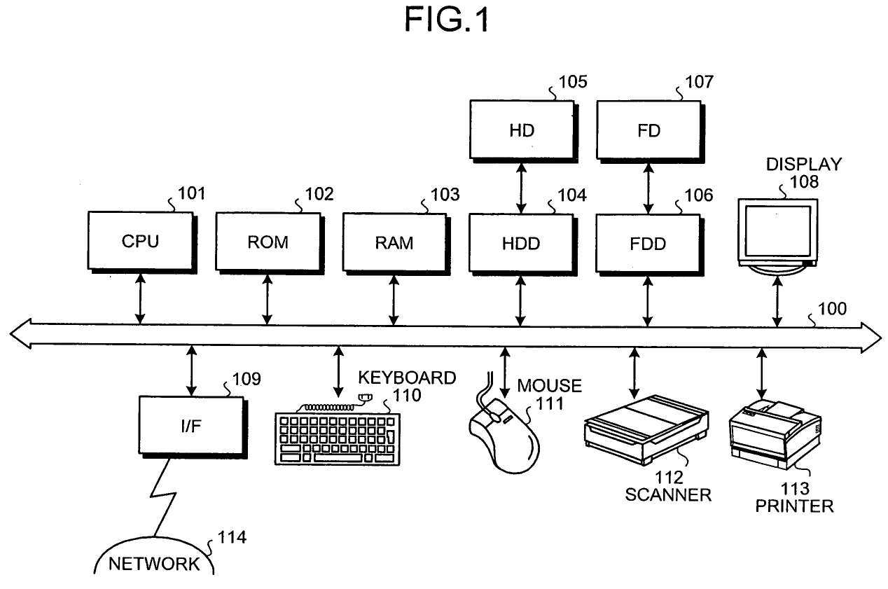

FIG. 1 is a schematic diagram illustrating a hardware configuration of a scroll control apparatus according to an embodiment of the present invention. As shown in FIG. 1, the scroll control apparatus includes a central processing unit (CPU) 101, a read-only memory (ROM) 102, a random access memory (RAM) 103, a had disk drive (HDD) 104, a hard disk (HD) 105, a flexible disk drive (FDD) 106, a flexible disk (FD) 107 as an example of a removable recording medium, a display 108, an interface (I/F) 109, a keyboard 110, a mouse 111, a scanner 112, and a printer 113. These components are interconnected via a bus 100.

The CPU 101 assumes control over the entire part of the scroll control apparatus. The ROM 102 stores programs including a boot program. The RAM 103 is used as a work area for the CPU 101. The HDD 104 follows control by the CPU 101 to control data reading/writing on the HD 105. The HD 105 stores data written thereon under control by the HDD 104.

The FDD 106 follows control by the CPU 101 to control data reading/writing on the FD 107. The FD 107 stores data written thereon under control by the FDD 106, and allows the controller body to read data stored in the FD 107.

The FD 107 may be replaced with a compact disc read-only memory (CD-ROM), a compact disc recordable (CD-R), a compact disc rewritable (CD-RW), a magneto optical (MO) disk, a digital versatile disk (DVD), a memory card, etc. The display 108 displays a cursor, icons, tool boxes, and other data of documents, images, and functional information. For example, a cathode ray tube (CRT), a thin-film transistor (TFT) crystal display, or a plasma display can be employed as the display 108.

The I/F 109 is connected to a network 114, such as the Internet, via a communication line, and is connected to an external device via the network 114. The I/F 109 assumes control over the network 114 and internal interfaces to control data input/output from/to the external device. For example, a modem or LAN adaptor can be employed as the I/F 109.

The keyboard 110 has keys for entering characters, numerals, various instructions, etc., serving for data input. The keyboard 110 may be replaced with a touch-panel input pad or a numeric keypad. The mouse 111 is used to move a cursor, select a range, move a window, change a window size, etc. The mouse 111 may be replaced with another pointing device having the same function as the mouse 111, such as a track ball or a joy stick.

The scanner 112 optically reads an image, and captures image data into the scroll control apparatus. The scanner 112 may be provided with an optical character recognition (OCR) function. The printer 113 prints out image data or document data. For example, a laser printer or ink jet printer can be employed as the printer 113.

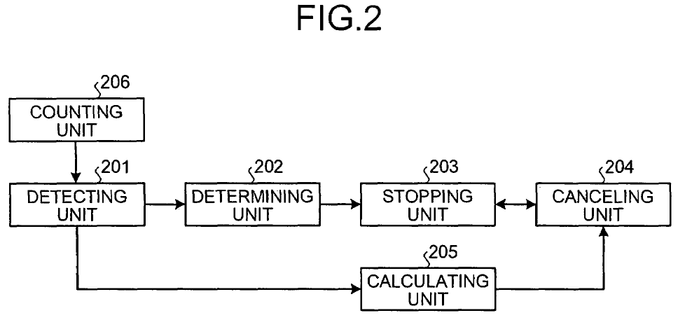

FIG. 2 is a block diagram illustrating a functional structure of the scroll control apparatus. As shown in FIG. 2, the scroll control apparatus includes a detecting unit 201, a determining unit 202, a stopping unit 203, a canceling unit 204, a calculating unit 205, and a counting unit 206.

The detecting unit 201 detects specific information out of image information displayed on a display screen during scrolling of displayable image information. “Scroll” means moving display contents on the display screen vertically and horizontally to bring hidden part of the image information into view on a display screen.

“During scrolling” indicates a state where the image information is being scrolled consecutively. An amount of scrolling, i.e., an amount of the image information to be scrolled, for one scroll operation is predetermined. Consecutive scroll operation, therefore, causes the image information to be scrolled consecutively in the predetermined amount of scrolling.

“Image information” means information of an image that is displayed on the display 108 through a mechanical process. Image information includes information of an image (picture), characters, and a background. A user, for example, can scroll image information consecutively by keep pressing a cursor key on the keyboard 110 or a scroll button.

The user can also scroll the image information consecutively in any desired direction by moving the body of the mouse 111 while keeping a wheel attached to the mouse 111 pressed as a button. The user may initiate automatic consecutive scrolling by executing a prescribed input operation. Further, the user can scroll the image information consecutively by pressing the scroll button repeatedly in series.

Specifically, the detecting unit 201 may detect an image that is displayed on the display screen as specific information. “Image” means a picture displayed on the display screen, which expresses a figure, photograph, graph, table, etc. An image can be a still image, moving image, etc.

The detecting unit 201 may detect a sentence composed of a predetermined number of lines or characters that is displayed on the display screen, as specific information. This predetermined number of lines or characters is determined by using, for example, the number of lines or characters shown on the display screen, the number of lines or characters shifted through one stroke of scrolling, or the number of lines or characters that a user can read all at once.

The predetermined number of lines or characters may be determined based on lengthwise and crosswise size of a display portion in which the image information is displayed on the display screen (specifically, the size of a window in which the image information is displayed on the display screen). Specifically, for example, when the lengthwise and crosswise size of the display screen is large (display screen is large), the predetermined number of lines or characters is determined to be greater. When the lengthwise and crosswise size of the display screen is small, the predetermined number is set to be smaller.

The detecting unit 201 may detect a predetermined string of characters that is displayed on the display screen, as specific information. This predetermined string of characters can be determined to be in any desirable form of, for example, highlighted characters, bold characters, a title, a specific key word, etc. In another method, the features of a string of characters displayed on the display screen are quantified and calculated, and the detecting unit 201 detects the predetermined string of characters using a result of the calculation.

The determining unit 202 determines on whether specific information detected by the detecting unit 201 is displayed at a predetermined position on the display screen. The predetermined position on the display screen can be determined in any desirable manner. Specifically, for example, any position on a line crossing a direction of scrolling may be determined to be the predetermined position on the display screen.

The line crossing the direction of scrolling may be determined in adjustment to a position that is matched to a spot where user's eyes is directed at when the user reads image information displayed on the display screen (e.g., the upper end of the display screen). In this case, the determining unit 202 may determine that the specific information is displayed at the predetermined position when the position of the image information overlaps any position on the line crossing the direction of scrolling.

The determining unit 202 may determine that the specific information is displayed at the predetermined position, just before the position of the image information overlaps any position on the line crossing the direction of scrolling. The point just before the overlapping means, for example, the point at which the position of the specific information and any position on the line crossing the direction of scrolling will overlap at the next cycle of scrolling.

The stopping unit 203 stops scrolling when the determining unit 202 determines that the specific information is displayed at a predetermined position. Specifically, the stopping unit 203 brings scrolling to a forcible stop when the specific information is displayed at the predetermined position even when input for consecutive scroll operation has been made.

The canceling unit 204 cancels the stop of scrolling when a predetermined time has passed since the stop of scrolling by the stopping unit 203. The predetermined time may be a time that is determined in advance for specific information detected by the detecting unit 201, or may be calculated for each specific information by the calculating unit 205, which will be described later. The predetermined time is, for example, linked to specific information, and is stored in a form of table in a recording medium such as the HD 105 and the FD 107.

When the predetermined time has passed since the stop of scrolling, therefore, the canceling unit 204 cancels the stop of scrolling, which is followed by the restart of scrolling of image information.

The calculation unit 205 calculates the predetermined time based on a specific piece of information detected by the detecting unit 201. Specifically, for example, the calculating unit 205 may calculate the predetermined time based on the ratio of an image detected by the detecting unit 201 to the display screen.

More specifically, for example, the calculation unit 205 calculates the predetermined time at a longer time when the ratio of the image detected by the detecting unit 201 to the display screen is large, and calculates the predetermined time at a shorter time when the ratio is small. This calculation is made using, for example, the following equation.

The predetermined time is expressed by T=(R/100)×M, where the predetermined time is T, a ratio is R, and the maximum predetermined time is M. The predetermined time T in proportion to the ratio R is acquired by substituting into this equation.

The calculating unit 205 may calculate the predetermined time based on the ratio of a sentence composed of a predetermined number of lines or characters, the sentence being detected by the detecting unit 201, to the display screen. Specifically, the calculation unit 205 calculates the predetermined time at a longer time when the ratio of a sentence composed of a predetermined number of lines or characters, the sentence being detected by the detecting unit 201, to the display screen is large, and calculates the predetermined time at a shorter time when the ratio is small.

The calculating unit 205 may calculate the predetermined time based on the color concentration of a sentence that is detected by the detecting unit 201, in a display area where the sentence is displayed in a frequency of appearance higher than a threshold. Specifically, the calculation unit 205 calculates the predetermined time at a longer time when the color concentration of the sentence is high on the display screen, and calculates the predetermined time at a shorter time when the color concentration is low.

Based on specific information detected by the detecting unit 201, the calculating unit 205 may calculate an amount of scrolling for forcible scrolling of image information displayed on the display screen when the stop of scrolling is canceled. Specifically, the calculating unit 205 calculates the amount of scrolling for forcible scrolling, using the display size of the specific piece of information detected by the detecting unit 201 in a direction of scrolling.

When the canceling unit 204 cancels the stop of scrolling, therefore, the image information is scrolled forcibly according to the amount of scrolling that is calculated by the calculating unit 205. This prevents a trouble that the determining unit 202 concludes display of the specific information at the predetermined position on the display screen to cause the stopping unit 203 to bring scrolling to a stop again despite of canceling of the stop of scrolling after the passage of the predetermined time.

The counting unit 206 counts the frequency of appearance of characters displayed in each of a plurality of display areas into which the display screen is divided. Specifically, for example, the counting unit 206 counts the sentence density (being great or small in the number of characters) of each display area based on a value indicating a color ratio of each display area and infers the frequency of appearance.

Based on a counting result given by the counting unit 206, the detecting unit 201 may detect a sentence displayed in a display area showing the frequency of appearance higher than a threshold among the plurality of display areas as specific information. Specifically, the detecting unit 201 detects a sentence displayed in a display area showing a high sentence density, using a counting result given by the counting unit 206.

The detecting unit 201, the determining unit 202, the stopping unit 203, the canceling unit 204, the calculating unit 205, and the counting unit 206 exert their functions, for example, as the CPU executes programs recorded in a recording medium shown in FIG. 1 such as the ROM 102, the RAM 103, the HD 105, and the FD 107.

When image information is scrolled consecutively on the scroll control apparatus, the image information is scrolled according to a preset number of scrolling (SC: scroll counter) of SC=A at the start of scrolling.

A represents an initial value for the number of scrolling (SC), and can be determined to be any desired value. For example, A may be determined to be a smaller value (e.g., SC=1) in consideration of a case where specific information is displayed at a predetermined position in a window (independent display area within the display 108) immediately after the start of scrolling.

An amount of scrolling of image information at one stroke of scrolling is also determined preliminary. For example, one-tenth of the number of lines displayable in a window may be determined to be an amount of scrolling. This means that image information displayed as one page of information is scrolled completely when the image information displayed in the window has been scrolled ten times (SC=10).

A time for stopping scrolling is expressed in terms of the number of idling scrolling (UC: unscroll counter). Specifically, a time for stopping scrolling at one stroke of idling scrolling is determined preliminary.

Scrolling is stopped for a certain span of time according to the number of idling scrolling (UC) determined for each specific information. For example, when a time for stopping scrolling at one stroke of idling scrolling is two seconds and the number of idling scrolling UC is three, the total time for stopping scrolling becomes six seconds, which is equivalent to the give time as mentioned above.

The number of scrolling (SC) and the number of idling scrolling (UC) are controlled by the CPU 101, and every altered, updated, or reset SC and/or UC is recorded anew in a scroll counter DB (data Base) built in a recording medium such as the HD 105 and the FD 107. Specifically, one is subtracted from the number of idling scrolling (UC) every time idling scrolling is carried out once.

A method of determining the number of scrolling (SC) and that of idling scrolling (UC) for each specific information displayed in a window will then be described in detail. Here, a direction of scrolling is limited to the vertical direction of the window, and a predetermined position in the window is fixed to the upper end of the window.

### SPECIFIC EXAMPLE (1)

### Scroll Control According to Presence/Absence of Image

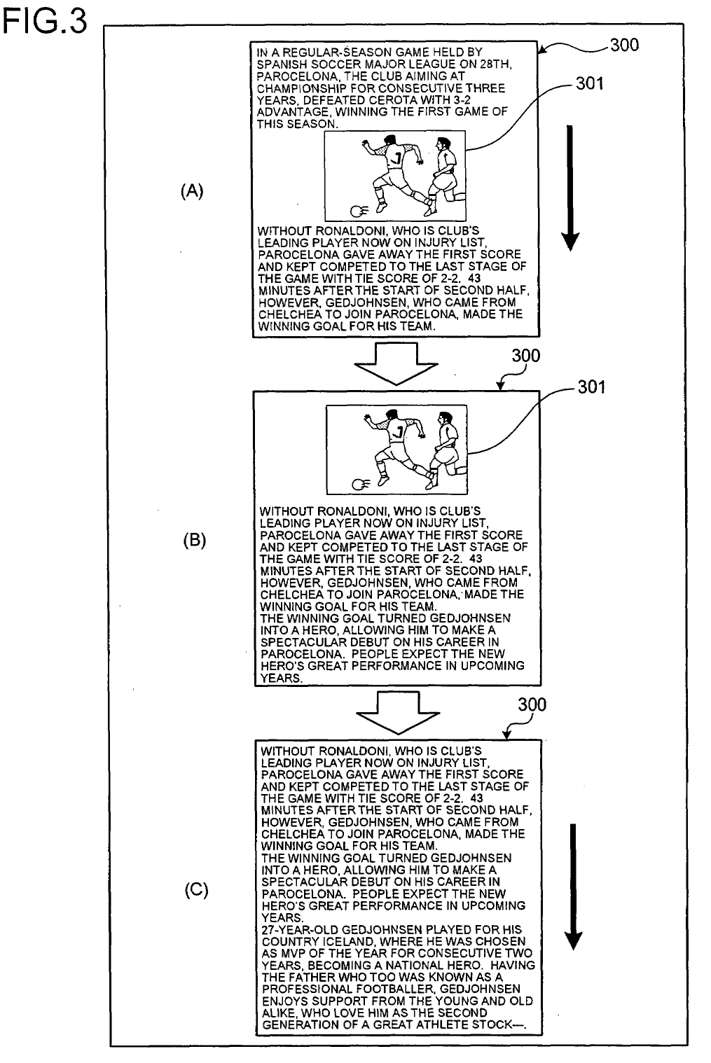

FIG. 3 is an explanatory view (1) of an example of scroll control. At the start of scrolling, as shown in FIG. 3, image information displayed in a window 300 is scrolled according to a predetermined number of scrolling (SC) ((A) in FIG. 3).

When the number of scrolling (SC) becomes SC=0 as a result of scrolling the image information, whether an image is displayed on the upper end of the window 300 is determined (a process equivalent to the process executed by the detecting unit 201 and the determining unit 202).

In the example shown in FIG. 3, image 301 is displayed on the upper end of the window 300 (a point right before the upper end of the window 300 in specific meaning). This brings a conclusion that the image is displayed on the upper end of the window 300, and idling scrolling is started despite of input for consecutive scroll operation (a process equivalent to the process executed by the above stopping unit 203) ((B) FIG. 3).

The number of idling scrolling (UC) is determined, for example, base on the ratio of the image 301 to the window 301 in area (a process equivalent to the process executed by the calculating unit 205). A ratio represents the proportion of two quantities to each other in comparison. The ratio mentioned here is the proportion of the display size of the image 301 to the display size (display area) of the window 300.

Specifically, when the display size of the image 301 is relatively small in comparison with the display size of the window 300, for example, when the size ratio of the image 301 to the window 300 is less than 15%, the number of idling scrolling (UC) may be determined to be smaller (UC=1 or 2). On the other hand, when the display size of the image 301 is relatively large in comparison with the display size of the window 300, for example, when the size ratio of the image 301 to the window 300 is 15% or more, the number of idling scrolling (UC) may be determined to be greater (UC=4 or 5).

The display size of the window 300 and that of the image 301, for example, can be expressed by the number of pixels. Specifically, for example, when the number of pixels in the entire window 300 is S and the number of pixels in the image 301 is P, a ratio R between the image 301 and the window 300 is given by R=(P/S)×100.

When the number of idling scrolling (UC) is determined from a predetermined ratio, a reference may be made to the table where ratios, the number of idling scrolling (UC), and the number of scrolling (SC) are linked to each other.

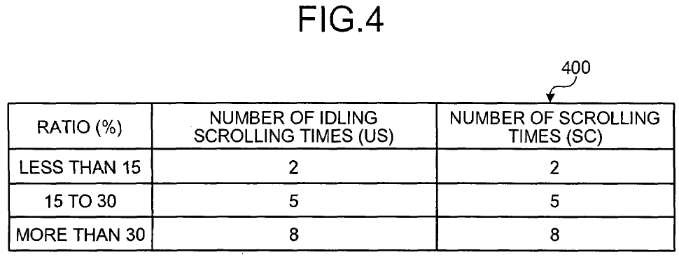

FIG. 4 is an explanatory view (1) of an example of the table. A table 400 shown in FIG. 4 exhibits ratios, the number of idling scrolling (UC), and the number of scrolling (SC) that are linked to each other. For example, when the ratio of the image 301 is 18%, the number of idling scrolling (UC) is determined to be UC=5 by referring to the table 400.

When idling scrolling is carried out according to a determined number of idling scrolling (UC) to bring a result of UC=0, image information may be scrolled forcibly according to a predetermined number of scrolling (SC). The forcible scrolling is carried out because when UC=0 results, determination on whether an image is displayed on the upper end of the window 300 is made again.

Specifically, the same determination process is repeated despite of completed idling scrolling leading to UC=0, so that idling scrolling is started again to keep scrolling stopped. To prevent this from happening, the image information is scrolled forcibly according to the predetermined number of scrolling (SC) when idling scrolling is over ((c) in FIG. 3).

The number of scrolling time (SC) in forcible scrolling may be determined based on the ratio of the image 301 to the window 300, which is the same way as the number of idling scrolling (UC) is determined (a process equivalent to the process executed by the calculating unit 205).

Specifically, when the ratio of the image 301 to the window 300 is 30% or lower, the number of scrolling (SC) may be determined to be smaller (SC=4 or 5). When the ratio of the image 301 to the window 300 is higher than 30%, the number of scrolling (SC) may be determined to be greater (SC=7 or 8).

As in the case of determination of the number of idling scrolling (UC), the number of scrolling (SC) may be determined by referring to the table 400. For example, when the ratio of the image 301 is 35%, the number of scrolling (SC) is determined to be SC=8 by referring to the table 400.

The number of scrolling (SC) may be determined by calculating an amount of scrolling required for causing the lower end of the image 301 to reach the upper end of the window 300 from the display size of the image 301 (dimension in a direction of scrolling). In other words, the number of scrolling (SC) needed to forcibly scroll the lower end of the image 301 up to the upper end of the window 300 is determined.

As described above, when an image is displayed on the upper end of the window 300, scrolling of image information is stopped. This prevents a user's failure in reading the image information, and enables efficient consecutive scrolling.

### SPECIFIC EXAMPLE (2)

### Scroll Control According to Display Size of Window

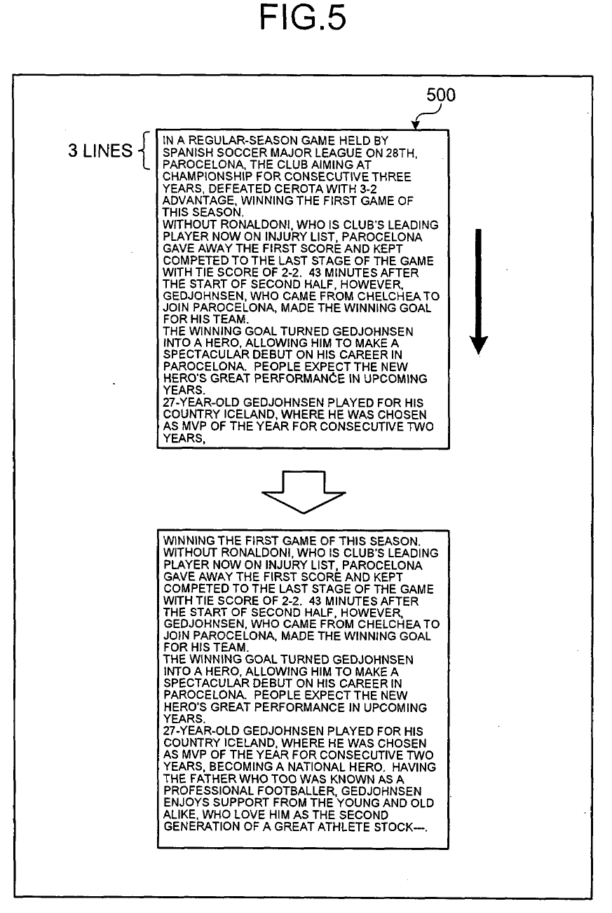

FIG. 5 is an explanatory view (2) of an example of scroll control. In this example, the number of scrolling (SC) and that of idling scrolling (UC) are determined based on the number of lines (or number of characters) of sentences displayed in a window 500. The number of scrolling (SC) will first be described. The number of scrolling (SC) is determined using any one of the following elements: the number of lines of sentences (WL) displayed in the window 500, an amount of scrolling (OL) of image information at one stroke of scrolling, the number of lines (B) a user can read all at once, and the number of times of scrolling stop (C) required to scroll the entire sentences displayed in the window 500.

The amount of scrolling (OL) of image information at one stroke of scrolling can be determined to be any desired amount. For example, when the amount of scrolling is determined to be three lines, OL=3. Likewise, the number of lines (B) the user can read all at once can also be determined to be any desired number. If the number of lines is determined to be ten, B=10.

The number of lines the user can read all at once means, for example, a volume of sentences that the user can read within the predetermined time or can understand at a glance. The number of times of scrolling stop (C) required to scroll the entire sentences displayed in the window 500 can also be determined to be any desired number. If the number of times is determined to be three, C=3.

The above values (WL, OL, B, C) are used to determine the number of scrolling (SC). Specifically, for example, when the number of lines (B) the user can read all at once is particularly considered, each value of B and OL is substituted for SC=B/OL to determine a value of SC, which is taken to be the number of scrolling (SC).

According to the example shown in FIG. 5, when the number of lines (B) the user can read all at once is given as B=3 and the amount of scrolling (OL) of image information at one stroke of scrolling is given as OL=1, the number of scrolling (SC) is determined to be SC=3/1=3. This means that when the image information displayed in the window 500 is scrolled, scrolling is stopped for every scrolling of three lines despite of given input for consecutive scroll operation.

When number of times of scrolling stop (C) required to scroll the entire sentences displayed in the window 500 is particularly considered, each value of WL, OL, and C is substituted for SC=WL/(OL×C) to determine a value of SC, which is taken to be the number of scrolling (SC).

The number of idling scrolling (UC) may be determined to be smaller, for example, determined to be UC=1, because the number of scrolling (SC) is determined in consideration of the number of lines (B) the user can read all at once. When UC=1 is given, scrolling the image information displayed in the window 500 causes idling scrolling of UC=1 for every scrolling of three lines.

On the other hand, when the number of lines (B) the user can read all at once is smaller than the amount of scrolling (OL) of lines at one stroke of scrolling, the number of idling scrolling (UC) may be determined by using the equation: UC=OL/B+1. This prevents a trouble that the displayed image information has been scrolled away as the user fails to read the image information.

As described above, a user's scroll operation resulting from the user's failure in reading image information during scrolling is prevented according to the number of lines of sentences displayed in the window 500. This enables efficient consecutive scrolling.

### SPECIFIC EXAMPLE (3)

### Scroll Control According to String of Characters with Features

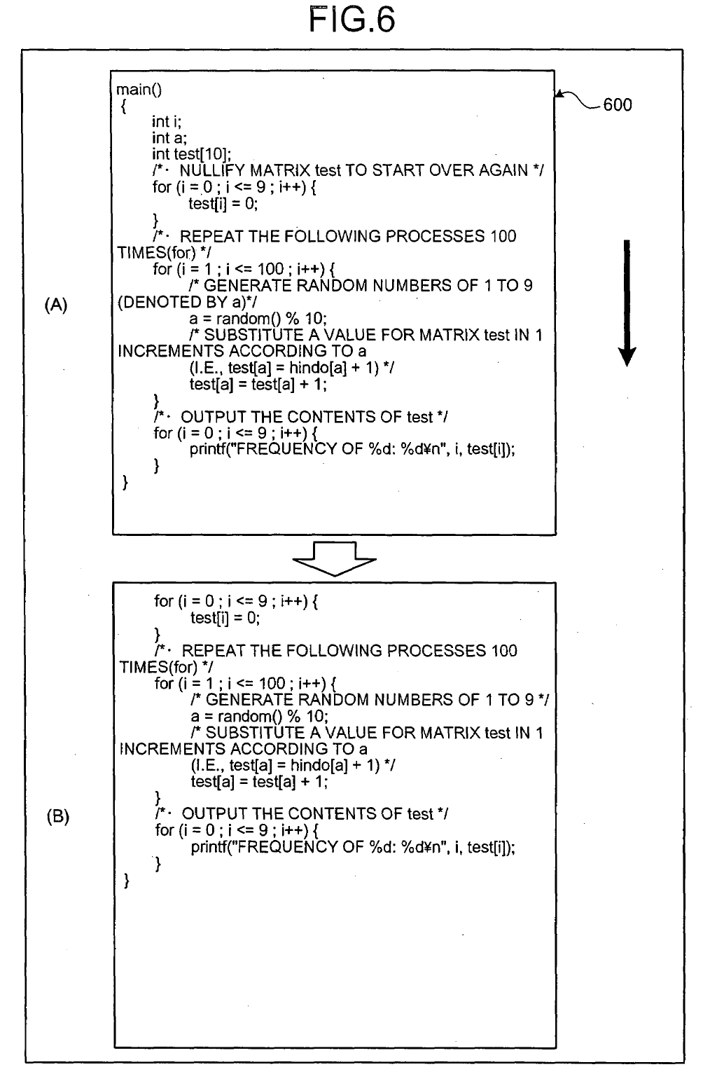

Scroll control of stopping scrolling according to a string of characters with features included in a sentence displayed in a window will then be described. FIG. 6 is an explanatory view (3) of an example of scroll control.

As shown in FIG. 6, an instance of a source program is displayed in a window 600. At the start of scrolling, image information (source program) displayed in the window 600 is scrolled according to a preset number of scrolling (SC) (FIG. 6(A)).

When the number of scrolling (SC) becomes SC=0 as a result of scrolling the image information, whether a string of characters with a given feature is displayed on the upper end of the window 600 is determined. The string of characters with the given feature can be determined to be in any desired form. For example, the string of characters may be a specific key word, highlighted characters, bold characters, a title, etc. Specifically, for example, a “for/while” statement indicating a vital part of the source program is determined to be the string of characters with the given feature.

When display of a string of characters with a given feature (in this example, “for”) on the upper end of the window 600 is concluded, idling scrolling is started despite of given input of consecutive scroll operation (FIG. 6(B)). The number of idling scrolling (UC) can be determined for every string of characters with a given feature displayed on the upper end of the window 600.

When the number of idling scrolling (UC) and that of scrolling times (SC) are determined, a reference may be made to a table where strings of characters, the number of idling scrolling (UC), and the number of scrolling (SC) are linked to each other.

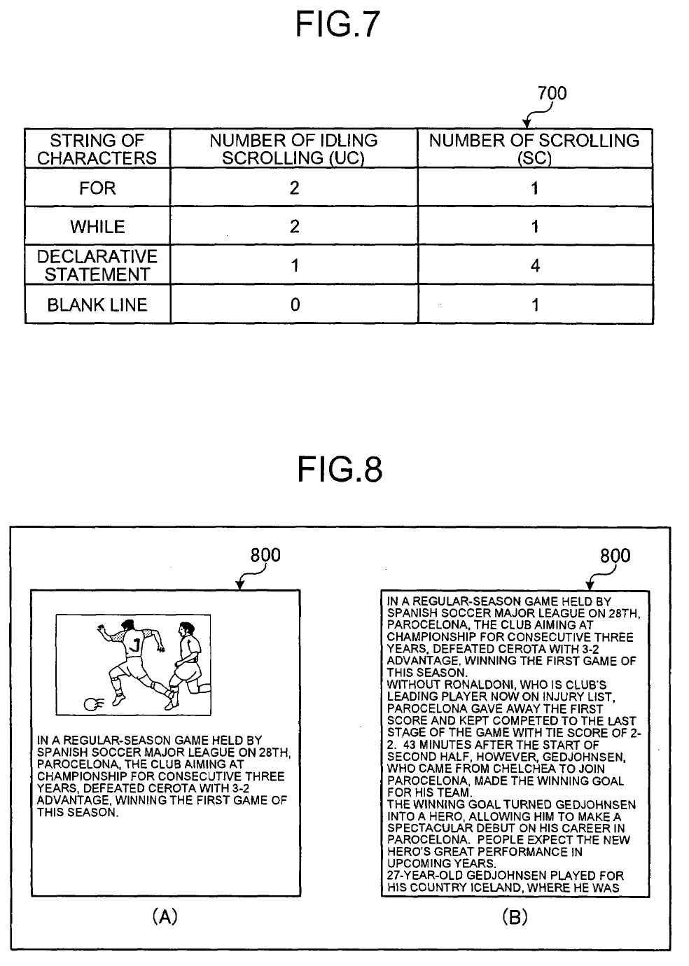

FIG. 7 is an explanatory view (2) of an example of the table. A table 700 shown in FIG. 7 exhibits strings of characters, the number of idling scrolling (UC), and the number of scrolling (SC) that are linked to each other.

For example, when display of a string of characters “for” on the upper end of the window 600 is concluded, the number of idling scrolling (UC) is determined to be UC=2 and the number of scrolling (SC) is determined to be SC=1 by referring to the table 700. In the same manner, when a declarative statement, such as a variable, is displayed on the upper end of the window 600, the number of idling scrolling (UC) is determined to be UC=1, and the number of scrolling (SC) is determined to be SC=4.

When a blank line appears on the upper end of the window 600, the numbers of idling scrolling (UC) is determined to be UC=0, and the number of scrolling (SC) is determined to be SC=1. The numbers of idling scrolling (UC) and that of scrolling times (SC) exhibited on the table 700 can be determined by considering the importance, e.g., importance in a source program, of a string of characters linked to the number of times.

When display of a loop statement “for/while” on the upper end of the window 600 is concluded, the number of scrolling (SC) and that of idling scrolling (UC) between the start point “{” and the end point “}” of the statement can be determined to be any desired number. Usually, a vital part of a source program is written between the start point “{” and the end point “}”, where “{” begins right after “for”. For this reason, idling scrolling is carried out frequently between the start point “{” and the end point “}”.

As described above, when a string of characters with a feature is displayed on the upper end of the window 600, scrolling of image information is stopped. This prevents a user's failure in reading the image information, and enables efficient consecutive scrolling.

### SPECIFIC EXAMPLE (4)

### Scroll Control According to Sentence Density

Scroll control of stopping scrolling according to the sentence density of image information displayed in a window will then be described. FIG. 8 is an explanatory view of an example of image information displayed in a window.

As shown in FIG. 8, pieces of image information having different sentence densities are displayed in a window 800. Usually, when a user peruses image information displayed in the window 800, the user feels difficulty in reading sentences when the sentences are many, and feels easiness in reading when the sentences are few. In this example, a proper number of idling scrolling (UC) and that of scrolling times (SC) are determined by considering the sentence density of image information displayed in the window 800.

To calculate the sentence density of image information, for example, the image information displayed in the window 800 is captured to make a histogram of the image information, and the histogram is analyzed. A histogram is a bar graph that exhibits the frequency of appearance of data on quantifiable elements or characteristics in each of a plurality of sections, which is provided by dividing an area in which the data are present.

In this example, the image information displayed in the window 800 is divided into a plurality of sections, and a color ratio of each section is quantified. The frequency of appearance of characters in each section can be inferred from the quantified color ratio. Utilizing a histogram in this manner allows an analysis on the distribution status of the appearance frequency (color ratio) of characters on the displayed image information. Based on an analysis result, the number of scrolling (SC) and that of idling scrolling (UC) are determined.

Specifically, for example, when data indicating a color ratio is small, a conclusion is made that characters are few and a background or picture occupies a large space. This leads to a determination of a greater number of scrolling (SC) and a smaller number of idling scrolling (UC) ((A) in FIG. 8). Specifically, for example, SC=4 and UC=1 are determined.

When data indicating a color ratio is large, a conclusion is made that characters are many, which leads to a determination of a smaller number of scrolling (SC) and greater number of idling scrolling (UC) ((B) in FIG. 8). Specifically, for example, SC=2 and UC=2 are determined.

Thus, when a sentence having a predetermined sentence density is displayed on the upper end of the window 600, scrolling of image information is stopped. This prevents a user's failure in reading the image information, and enables efficient consecutive scrolling.

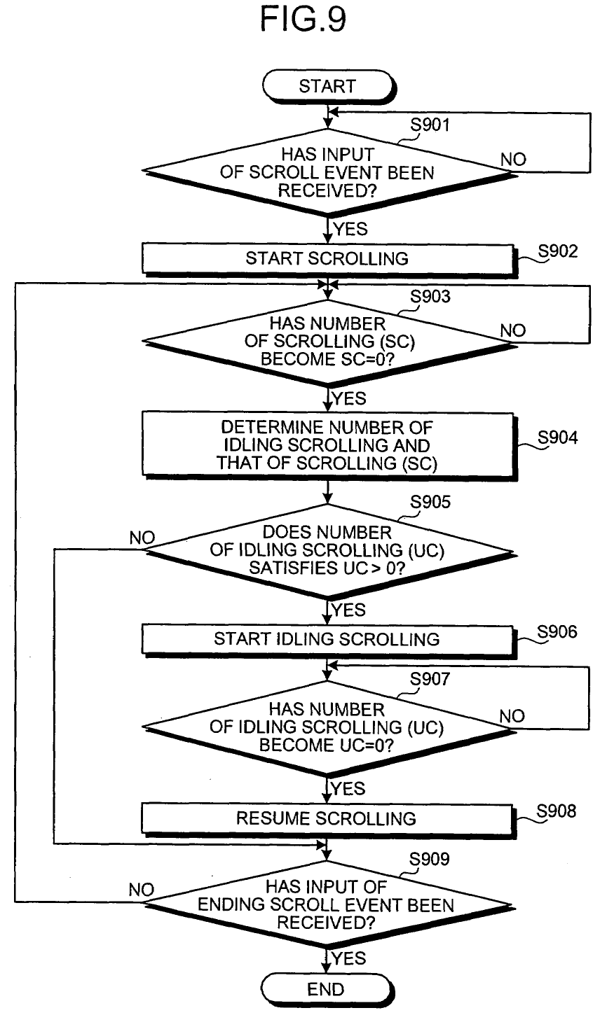

FIG. 9 is a flowchart of a scroll control process executed by the scroll control apparatus. The following description gives the detail of the scroll control process that is executed when displayed information on the display 108 is scrolled consecutively.

At the start of the flowchart in FIG. 9, the scroll control apparatus determines on whether the controller has received input of a scroll event (step S901). Input of a scrolling event means input of operation of consecutively scrolling image information displayed on the display 108. Specifically, for example, a user keeps depressing the scrolling button on the keyboard 110 to scroll the image information consecutively.

Waiting for input of a scroll event, the scroll control apparatus starts scrolling displayed information on the display 108 (step S902) when the scroll event has been put in (“YES” at step S901). Specifically, the displayed information is scrolled according to a preset amount of scrolling (OL) of image information at one stroke of scrolling and a preset number of scrolling (SC).

The scroll control apparatus then determines on whether the number of scrolling (SC) has become SC=0 (step S903). Specifically, one is deducted from the number of scrolling (SC) for every execution of one stroke of scrolling by the CPU 101, and whether SC=0 has ultimately resulted is determined.

The scroll control apparatus waits for the number of scrolling (SC) to become SC=0, and, when SC=0 results (“YES” at step S903), determines the number of idling scrolling (UC) and the number of scrolling (SC) (step S904) based on image information displayed on the display 108.

Specifically, the number of idling scrolling (UC) and the number of scrolling (SC) are determined based on the image information displayed at a predetermined position on the display 108. For example, when an image is displayed at the predetermined position on the display 108 and the ratio of the image to the display 108 is 10%, the number of idling scrolling (UC) is determined to be UC=2 and that of scrolling times (SC) is determined to be SC=2 by-referring to the table 400 shown in FIG. 4.

The scroll control apparatus then determines on whether the number of idling scrolling (UC) determined at step 904 satisfies UC>0 (step S905). When the number of idling scrolling (UC) satisfies UC>0 (“YES” at step S905), idling scrolling is started (step S906).

Specifically, scrolling of the image information is stopped according to the number of idling scrolling (UC) determined at step 904 despite of the reception of scroll event input at step S901. On the other hand, when the number of idling scrolling (UC) does not satisfy UC>0 (“NO” at step S905), the scroll control apparatus proceeds to step S909.

The scroll control apparatus then determines on whether the number of idling scrolling (UC) has become SC=0 as a result of idling scrolling (step S907). Specifically, one is deducted from the number of idling scrolling (UC) for every execution of one stroke of idling scrolling by the CPU 101, and whether UC=0 has ultimately resulted is determined.

The scroll control apparatus waits for the number of idling scrolling (UC) to become UC=0, and, when UC=0 results (“YES” at step S907), cancels the stop of scrolling to resume scrolling of the image information displayed on the display 108 (step S908). Specifically, the image information is scrolled according to the number of scrolling (SC) determined at step 904.

Subsequently, the scroll control apparatus determines whether the controller has received input for ending the scroll event (step S909). Input for ending the scroll event means input of operation of ending scrolling of the displayed information on the display 108.

Specifically, for example, when the user removes the user's finger from the scrolling button, which is kept pressed by the user to consecutively scroll the image information, the scroll control apparatus concludes the reception of input for ending the scroll event. When consecutive scrolling has been carried out automatically, the scroll control apparatus concludes the reception of input for ending the scroll event when the user executes operation involving the end of the scroll event.

Upon receiving input for ending the scroll event (“YES” at step S909), the scroll control apparatus ceases a series of steps depicted in the flowchart. Specifically, the scroll control apparatus ceases the scroll control process and resets the number of idling scrolling (UC) and that of scrolling times (SC) recorded in the scroll counter DB (put the number of times back to the initial value) when receiving input for ending the scroll event.

When receiving no input for ending the scroll event (“NO” at step S909), the scroll control apparatus returns to step S903 to repeat the series of steps.

According to the flowchart, the determination on the reception of input for ending the scroll event is made at step S909. The scroll control apparatus, however, may be so structured as to make this determination constantly during the series of steps. This means that the scroll control apparatus ceases the scroll control process at any point of reception of input for ending the scroll event during the series of steps.

As described above, when specific information is displayed at a predetermined position on the display 108, scrolling of image information is stopped. This prevents failure in reading the image information, and enables efficient consecutive scrolling.

The above description is made on the scroll control method applying to a case where image information is scrolled consecutively from bottom to top. This scroll control method, however, enables the same scroll control as described above when the image information is scrolled from top to bottom, or the left to the right and vice versa.

According to the above scroll control program, recording medium, scroll control apparatus, and scroll control method, when specific information is displayed at a predetermined position on the display screen, scrolling of image information can be stopped despite of given input of operation for consecutive scrolling.

This prevents failure in reading the image information during scrolling, and enables efficient consecutive scrolling.

Even if the display screen is shaken while walking, the user can easily read the image information because scrolling is stopped when specific information is displayed.

In application to a public facility, when information displayed on a screen are scrolled automatically, readers are not allowed to carry out scroll operation at will but scrolling is stopped when specific information (e.g., important information) is displayed, so that failure in reading the important information is prevented.

The scroll control method according to the present embodiment can be realized by causing a computer, such as personal computer and work station, to execute a program prepared in advance. This program is recorded on a computer-readable recording medium such as an HD, an FD, a CD-ROM, an MO, a DVD, etc., and is executed as the computer reads the program out of the recording medium. The program may be a transmission medium that can be distributed via a network, such as the Internet.

According to the embodiments described above, it is possible to prevent failure of user reading image information during the image information is scrolled.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein a scroll control program causing a computer to execute:
detecting, during a scroll operation of image information, specific information from a displayed portion of the image information, the displayed portion being a portion displayed on a display screen;
determining whether the detected specific information is displayed at a predetermined position on the display screen; and
stopping the scroll operation when it is determined that the specific information is displayed at the predetermined position at the determining.

2. The computer-readable recording medium according to claim 1, wherein the scroll control program further causes the computer to execute canceling the stopping when a predetermined time has elapsed since the scroll operation is stopped at the stopping.

3. The computer-readable recording medium according to claim 2, wherein
the scroll control program further causes the computer to execute calculating the predetermined time based on the detected specific information, and
the cancelling includes cancelling the stopping based on the calculated predetermined time.

4. The computer-readable recording medium according to claim 1, wherein the specific information includes an image displayed on the display screen.

5. The computer-readable recording medium according to claim 4, wherein
the scroll control program further causes the computer to execute calculating the predetermined time based on a ratio of a display area of the detected image to an area of the display screen, and
the cancelling includes cancelling the stopping based on the calculated predetermined time.

6. The computer-readable recording medium according to claim 1, wherein the specific information includes a sentence including a predetermined amount of characters displayed on the display screen.

7. The computer-readable recording medium according to claim 6, wherein
the scroll control program further causes the computer to execute calculating the predetermined time based on a ratio of a display area of the detected sentence to an area of the display screen, and
the cancelling includes cancelling the stopping based on the calculated predetermined time.

8. The computer-readable recording medium according to claim 1, wherein the specific information includes a character string displayed on the display screen.

9. The computer-readable recording medium according to claim 1, wherein
the scroll control program further causes the computer to execute counting frequency of appearance of characters displayed in each of a plurality of display sections obtained by sectioning the display screen, and
the specific information includes a sentence displayed in a display section having the frequency higher than a threshold among the display sections.

10. The computer-readable recording medium according to claim 9, wherein
the scroll control program further causes the computer to execute calculating the predetermined time based on color concentration of the sentence displayed in the display section having the frequency higher than the threshold, and
the cancelling includes cancelling the stopping based on the calculated predetermined time.

11. A scroll control apparatus comprising:
a detecting unit that detects, during a scroll operation of image information, a specific information from a displayed portion of the image information, the displayed portion being a portion displayed on a display screen;
a determining unit that determines whether the detected specific information is displayed at a predetermined position on the display screen; and
a stopping unit that stops the scroll operation when it is determined that the specific information is displayed at the predetermined position by the determining unit.

12. The scroll control apparatus according to claim 11, further comprising a cancelling unit that cancels the stopping when a predetermined time has elapsed since the scroll operation is stopped by the stopping unit.

13. A scroll control method comprising:
detecting, during a scroll operation of image information, specific information from a displayed portion of the image information, the displayed portion being a portion displayed on a display screen;
determining whether the detected specific information is displayed at a predetermined position on the display screen; and
stopping the scroll operation when it is determined that the specific information is displayed at the predetermined position at the determination.

14. The scroll control method according to claim 13, wherein the scroll control program further causes the computer to execute canceling the stopping when a predetermined time has elapsed since the scroll operation is stopped at the stopping.
